(19) United States
(12) Patent Application Publication
(10) Pub. No.: US 2021/0280001 A1
(43) Pub. Date: Sep. 9, 2021

(54) APPARATUS AND METHODS FOR HUMAN-MACHINE INTERACTION

(71) Applicant: Takara Gaming Solutions Limited, Hong Kong (HK)

(72) Inventors: Yui Man Raymond Chan, Hong Kong (HK); Ka Lun Ernie Suek, Hong Kong (HK)

(21) Appl. No.: 16/478,868

(22) PCT Filed: Jan. 18, 2018
(86) PCT No.: PCT/IB2018/050302

§ 371 Date: Jul. 18, 2019

(30) Foreign Application Priority Data
Jan. 18, 2017 (HK) 17100635.2

(51) Int. Cl. G07F 17/32

(52) U.S. Cl. CPC G07F 17/3223; G07F 17/329; G07F 17/3293; G07F 17/3211

(57) ABSTRACT

An apparatus comprising a controller, a data storage device (114), a user operable user interface (116) and a display apparatus (118), wherein the controller is to execute stored instructions to operate to implement a gaming process comprising a first stage operation and a second stage operation. A method of implementing a gaming process by a machine comprising a solid-state controller comprising a microprocessor (112), wherein the gaming process comprises a first stage operation and a second stage operation.

### FIELD

The present disclosure relates to methods and apparatus involving human-machine interaction, for example, interactive gaming methods executable by machines and machine for implementing interactive gaming methods.

### BACKGROUND

Interactive methods that require mind and motor coordination are beneficial for human health. Interactive games that involve evaluation of symbols carrying numeric values and requires decision making of a user dependent on symbols and/or numeric values are examples of mind and motor exercises that confer health benefits for human well-beings. However, many brain and motor exercises require teams or partners which may not be always available.

It would be beneficial to provide means so that brain and motor exercises can be performed through human-machine interactions. Player and machine interactions are known to be useful in providing exercise and training to enhance physical coordination, memory and responsiveness.

### DISCLOSURE

An apparatus comprising a controller, a data storage device, a user operable user interface and a display apparatus to operate to operate a process such as a gaming process is disclosed. The controller is to execute stored instructions to operate to implement a gaming process comprising a first stage operation and a second stage operation.

In the first stage operation, the controller is to issue a first set of information bearing devices forming a first portion of a host hand and/or a first portion of a user hand having a corresponding expected value of return-to-player, wherein the controller is to provide the user with an option to use a feature at a premium, and the use of the feature is to result in a change in expected return-to-player. The controller is to implement the feature upon receipt of the premium and upon receipt of user instruction to proceed to the second stage operation.

In the second stage operation, the controller is to issue a second set of information bearing devices forming a second portion of the host hand to form a complete host hand and/or a second portion of a user hand to form a complete user hand, and the controller is to determine process outcome of the process and payout with reference to the user hand and the host hand.

The gaming process may have more than the first and second stage operations without loss of generality.

The premium may be dynamically determined by the controller with reference to the user hand and with reference to the extent of change in expected return-to-player with respect to the expected return-to-player prior to using the feature.

The controller may set the premium to commensurate with the instantaneous change in return-to-player.

The user may contribute the premium to the host by operation of the user interface and the controller is to implement the feature upon detection of contribution of the premium.

The change in expected return-to-player can be positive or negative, and the premium can be positive or negative.

A method of implementing a gaming process comprising a first stage operation and a second stage operation by a machine comprising a solid-state controller comprising a microprocessor is disclosed.

The method comprises the controller:
executing stored instructions to issue a first set of information bearing devices forming a first portion of a host hand and/or a first portion of a user hand having a corresponding expected value of return-to-player,
providing the user with an option to use a feature at a premium, and the use of the feature is to result in a change in expected return-to-player,
implementing the feature upon receipt of the premium and upon receipt of user instruction to proceed to the second stage operation in the first stage of operation;
issuing a second set of information bearing devices forming a second portion of the host hand to form a complete host hand and/or a second portion of a user hand to form a complete user hand, and
determining process outcome of the process and payout with reference to the user hand and the host hand in the second stage of operation.

The second stage of operation may be an optional stage and the controller is to compute the change in expected return-to-player at end of the first stage of operation and determine the premium payable by the user.

The controller in the first operation stage may operate as a dealing host to select a first set of information bearing devices from a pool of information bearing devices forming a deck, and to present the first set of information bearing devices on the display apparatus to represent the first portion of the user hand which is distributed by the host to the user at beginning of process after the host has received a user contribution of value in form of an ante, wherein the user hand has an accompanying expected rate of return-to-player defining an initial RTP, and the user is expected to make a decision to perform a next move and to inform the controller to perform the next move through operation of the user interface.

### FIGURES

The present disclosure will be described by way of example and with reference to the accompanying figures, in which

FIG. 1 is a block diagram of a machine configured to implement a process of the disclosure,

FIG. 2 is a flow diagram showing an example flow of process according to the disclosure,

FIG. 3 is a chart showing example premiums (or increase in RTP) versus score values of player's initial hand and comparisons of average RTP premium, fixed premium and dynamic premium,

FIG. 4 is a flow diagram depicting determination of premiums for mini-poker example,

FIG. 5 is a chart showing a comparison of premiums in an example process, and

FIG. 6 is a graph showing a trend of dynamic premium of the example method of FIG. 5.

### DESCRIPTION

A standard set of playing cards has 52 cards which are divided into four suits. The four suits are spade, club, heart and diamond, and each suit has 13 cards. There are nine numbered cards which are numbered 2 to 10 and four alphabet cards bearing the alphabets A, K, Q, and J. The ‘A’ card is also referred to as ‘Ace’ or ‘Ace’ card, the ‘K’ card is also referred to as ‘King’ or ‘King’ card, the ‘Q’ card is also referred to as ‘Queen’ or ‘Queen’ card, and the ‘J’ card is also referred to as ‘Jack’ or ‘Jack’ card. The K, Q, and J cards are also known as face cards or figure cards. Each card of the deck of player cards is an example information bearing device on which information representing a value and/or other characteristics is presented.

An example method of the present disclosure is illustrated as a card game having rules similar to a game which is known as “Blackjack” or “twenty-one points” to facilitate understanding of the present disclosure. Basic rules of the Blackjack game are incorporated herein by reference for succinctness.

An example method herein is in the form of a scoring game which is played between a host and one player or a plurality of up to four players. Each of the numbered card has a score value equal to the face value of the card. Each of the face card has a score value of 10 and each Ace card can have a score value of 1 or 11. At initiation of the game, the host issues a player hand of two cards to a player or each player and issues a host hand of two cards to itself after each player has made a contribution of value in the form of ante or wager. Each hand of cards caries a total score value. The total score value is a sum of values of the cards forming the hand. The issued cards are issued from a deck of cards comprising the 52 cards of a standard set of playing cards. After a player hand has been issued, a player may choose to request for an additional card, to stay with what have been issued or to give up to surrender. A player is said to make a hit (‘Hit’) if the player requests for an additional card. A player is said to make a stand (‘Stand’) if the player chooses to stay with what is issued. If the player chooses to surrender (‘Surrender’) after the initial player hand has been issued, the player will only lose half of the ante on surrender. If a player elects to make a hit, the player will be issued an additional card. The player can continue to make requests for additional cards and additional cards will be issued to the player until the player hand reaches a maximum score or is busted. The example maximum score is 21 points. When a hand of cards has a score higher than 21 points, the hand is a busted hand and the player will automatically lose or enter into default. When a hand is busted, the hand will have an instant total value of zero, which is a definite lose regardless of the outcome of the host hand. After all additional card requests of the players have been met, the host will proceed to the next stage and decide on whether to get an additional card, unless the host is required to get an additional card or cards involuntarily according to rules. In example rules, the host has to issue an additional card or additional cards to itself until the host hand has a score of 17, except when the host has a score of a soft 17 in which case the host must get an additional card. A hand having an ace and one or more other cards totaling six is known as a soft 17.

After all additional cards have been issued or if no additional card is to issue, the host and each player are to proceed to the next stage and to compare score values to determine outcome. A hand having a higher score value is a winning hand. A player having a winning hand is entitled to a payout equal to the value of the ante. A player having a hand of Blackjack, comprising an Ace plus a ten or a face card, is entitled to a doubled pay-out.

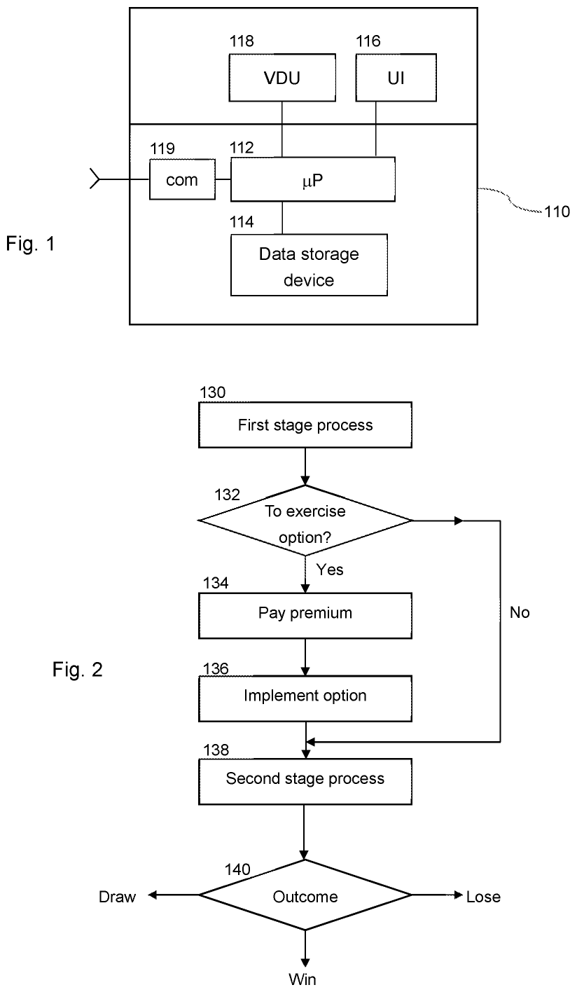

Example embodiments are implemented using a machine to facilitate user-machine interaction. An example machine suitable for implementing embodiments of the present disclosure comprises a housing 110, a controller comprising a microprocessor 112, a data storage device 114 comprising volatile memories such as RAM and/or non-volatile memories, a user operable user interface 116, a video display unit (VDU) 118 and an optional communication front end 119, as depicted in FIG. 1. The VDU and the UI may be detachable or separate from the main housing 110. An application software implementing a method of the present disclosure is resident in the machine and the controller is to activate the application software by loading the software to its volatile memories and to execute the stored instructions defined by the application software during operations implementing methods of the present disclosure.

To promote user-machine interaction, the machine is to provide a user with exercisable options. An example of exercisable options is a peeping option nicknamed ‘Peek the hole’ or ‘Peek the Host's hands’. Exercise of this option enables a player to see through or ‘peep’ the cards of the host before the player makes a decision whether to hit, to stand or to surrender.

In an example process, a player is initially issued or dealt a player hand having a “9 of heart” and a “7 of spade”, scoring a total of 16 points initially. The host is initially issued a “7 of heart” and an unknown card which is faced down. The unknown card can have a score value of any value between 1 and 11. Each score value of the hidden card has associated values of RTP if to hit, to stand or to surrender, and the values are set out in Table 1.

TABLE 1
(process example 1)

| Host Hand | Hit | Stand | Surrender | Max |
|---|---|---|---|---|
| A + 7 | 53.8% | 0.0% | 50.0% | 53.8% |
| 2 + 7 | 49.0% | 45.0% | 50.0% | 50.0% |
| 3 + 7 | 45.9% | 45.6% | 50.0% | 50.0% |
| 4 + 7 | 34.4% | 42.0% | 50.0% | 50.0% |
| 5 + 7 | 57.0% | 96.5% | 50.0% | 96.5% |
| 6 + 7 | 58.4% | 103.9% | 50.0% | 103.9% |
| 7 + 7 | 59.8% | 110.8% | 50.0% | 110.8% |
| 8 + 7 | 61.0% | 117.2% | 50.0% | 117.2% |
| 9 + 7 | 62.1% | 123.1% | 50.0% | 123.1% |
| 10 + 7 | 69.2% | 0.0% | 50.0% | 69.2% |
| J + 7 | 69.2% | 0.0% | 50.0% | 69.2% |
| Q + 7 | 69.2% | 0.0% | 50.0% | 69.2% |
| K + 7 | 69.2% | 0.0% | 50.0% | 69.2% |
| average | 58.7% | 52.6% | 50.0% | 79.4% |

| | |
|---|---|
| E(RTP) | 79.4% |

If the host hand is fully transparent to the player, a player can opt to make a move that would correspond to or result in a maximum expected RTP and a sensible player will be expected to make such a move. However, under this situation, a player does not have a full knowledge of the host hand and can only work on the basis of average or expected RTPs. Under this half-open or half-hidden host hand situation, a player will have an expected RTP of 58.5% if to hit (that is get one more card), an expected RTP of 52.5% if to stand (that is, not getting an extra card), and an expected RTP of 50% if to surrender. A player would normally be expected to make a move that would correspond to or result in a maximum expected RTP, and the maximum RTP here corresponds to a move to make a Hit. RTP (return-to-player) is a term that measures a probability of expected return to a player, with a 100% RTP meaning the player can expect to get a return equal to the value of the ante, etc.

If the player is allowed to peep or look through the host hand, the cards and values of the host hand become readily apparent or transparent to the player and uncertainty is substantially reduced. With the enhanced transparency, the maximum RTPs associated with all the possible values of the hidden card can be calculated. As the maximum RTP associated with each possible value of the hidden card is known, a player can operate on the basis of an average of the maximum RTP values of all the possible values, rather than selecting a maximum among the average of the RTPs to hit, the average of the RTPs to stand, and the average of the RTPs to surrender.

The average of the maximum RTP values of all the possible values, E(RTP), is set out in the last column of Table 1 and is calculated according to the expression below.

E(RTP)=(Maximum of RTP of (A+7)+Maximum of RTP of (2+7)+Maximum of RTP of (3+7)+Maximum of RTP of (4+7)+Maximum of RTP of (5+7)+Maximum of RTP of (6+7)+Maximum of RTP of (4+7)+Maximum of RTP of (5+7)+Maximum of RTP of (6+7)+Maximum of RTP of (10+7)+Maximum of RTP of (J+7)+Maximum of RTP of (Q+7)+Maximum of RTP of (K+7))/13=79.4%.

The resulting E(RTP) is derived on the assumption that a sensible player or an ordinary player would be expected to elect an option having the highest RTP to move forward, and the expected RTP, or E(RTP) would be an average of all the maximum RTP set out in the last column of Table 1. Therefore, when a player is able to see the hidden card, the resulting expected RTP (E(RTP)) will increase from 58.7% to 79.4%, representing an increase of RTP by 20.7%.

In example processes, a player would be required to pay a fee, known as a feature fee, as a premium in order to exercise the option to peep, so that the increase in RTP is equalized, including partially equalized, totally equalized or over equalized. When the increase in RTP is partially equalized, there is still an increase in RTP in the player's favor. When the increase in RTP is totally equalized, there is no increase in RTP in the player's favor. When the increase in RTP is over equalized, there is a decrease in RTP in the player's detriment. For example, if the premium payable is set to be 20.7% of the value of the wager or ante, the apparent gain in RTP is totally equalized. Alternative, the premium may be set higher to gain house edge or lower to attract player participation. The RTP and gain in RTP are not static and are dependent on the values of the instant hands.

In an example process, a player is initially issued a player hand having a “9 of heart” and a “8 of spade”, scoring a total of 17 points initially. The host is initially issued a “7 of heart” and a hidden which is faced down. The hidden card can have a score value of between 1 and 11. On the basis of this half-open or half-hidden host hand situation, a player will have an RTP of 51.8% if to hit (that is get one more card), an RTP of 89.5% if to stand (that is, not getting an extra card), and an RTP of 50% if to surrender, as depicted in Table 2 below.

TABLE 2
(process example 2)

| Dealer's Hand | Hit | Stand | Surrender | Max |
|---|---|---|---|---|
| A + 7 | 53.8% | 0.0% | 50.0% | 53.8% |
| 2 + 7 | 44.6% | 57.1% | 50.0% | 57.1% |
| 3 + 7 | 41.5% | 57.7% | 50.0% | 57.7% |
| 4 + 7 | 35.3% | 53.0% | 50.0% | 50.0% |
| 5 + 7 | 48.8% | 106.8% | 50.0% | 106.8% |
| 6 + 7 | 49.7% | 113.5% | 50.0% | 113.5% |
| 7 + 7 | 50.6% | 119.7% | 50.0% | 119.7% |
| 8 + 7 | 51.3% | 125.4% | 50.0% | 125.4% |
| 9 + 7 | 52.1% | 130.8% | 50.0% | 130.8% |
| 10 + 7 | 61.5% | 100.0% | 50.0% | 100.0% |
| J + 7 | 61.5% | 100.0% | 50.0% | 100.0% |
| Q + 7 | 61.5% | 100.0% | 50.0% | 100.0% |
| K + 7 | 61.5% | 100.0% | 50.0% | 100.0% |
| Average | 51.8% | 89.5% | 50% | 93.3% |

| | |
|---|---|
| E(RTP) | 93.3% |

Therefore, if a player is able to see the hidden card, the expected RTP E(RTP) will increase from 89.5% to 93.3%, representing an increase of about 4% only. For example, the premium payable may be set to be around 4% of the wager placed in order to equalize or mitigate the apparent gain in RTP.

The example processes 1 and 2 are somewhat simplistic and are based on a single host and a single player. Where there is a plurality of players, the RTP will change according to cards which have been issued and cards which remain to be available for distribution and more exhaustive calculation is required.

In example processes of example methods, the machine is to issue the host hand and the player hand (or a plurality of player hands up to 3) in initialization after receipt of initial contribution from a player or players. After the host hand and the player hand have been issued, the machine will invite the player to exercise an option to use a feature, which is the peeping feature in this example. The machine may make the invite, for example, by generating an invite message on the VDU. The invite message would also contain the price for exercising the option. A player will respond to the invite and inform the controller of its intention whether to use the feature at the price by responding using the UI (user interface). If a player responds in the affirmative to use the option, the player will need to pay the premium before the feature can be used. The payment may be effected or materialized by automatic debiting from the player's account by the controller, by the player making a payment electronically through operation of the UI, or other appropriate means without loss of generality. In some embodiments, the premium may be set at a fixed amount not tied to the cards or the increase in RTP.

Therefore, the example process comprises a first stage operation and a second stage operation, as depicted in FIG. 2. In the first stage operation 130, the host is to operate to issue a first portion of the host hand and a first portion of the player hand. After the first stage process 130 has completed, a player is to decide at 132 whether to exercise an option. If the player decides to exercise option, a player is to pay a premium at 134 and the host is to implement the option feature at 136. If the player decides not to exercise an option or an option has been implemented, the host will proceed to run the second stage process at 138 and outcome of process is determined at 140, as depicted in FIG. 2. In the second stage process, the host will act according to instructions of the player whether to hit, to stand or to surrender, and to complete the formation of the host hand depending on the host hand and outcome of the player hand. For example, the host will need to get an additional card if below a soft 17 and the player hand is not busted.

By taking into account all possibilities of the exposed cards of the host hand, an average increase in RTP resulting from this example option is set out in Table 3 below.

TABLE 3

| | Player scores | | | | | | | | | |
|---|---|---|---|---|---|---|---|---|---|---|
| | 12 | 13 | 14 | 15 | 16 | 17 | 18 | 19 | 20 | 21 |
| Average | 12.21% | 14.12% | 15.64% | 17.04% | 18.01% | 15.17% | 12.16% | 7.58% | 0.38% | 0.00% |
| Premium | | | | | | | | | | |
| Dynamic | 14% | 16% | 16% | 18% | 20% | 16% | 14% | 8% | 2% | 0% |
| Fee | | | | | | | | | | |
| Fixed | 20% | 20% | 20% | 20% | 20% | 20% | 20% | 20% | 20% | 20% |
| Fee | | | | | | | | | | |

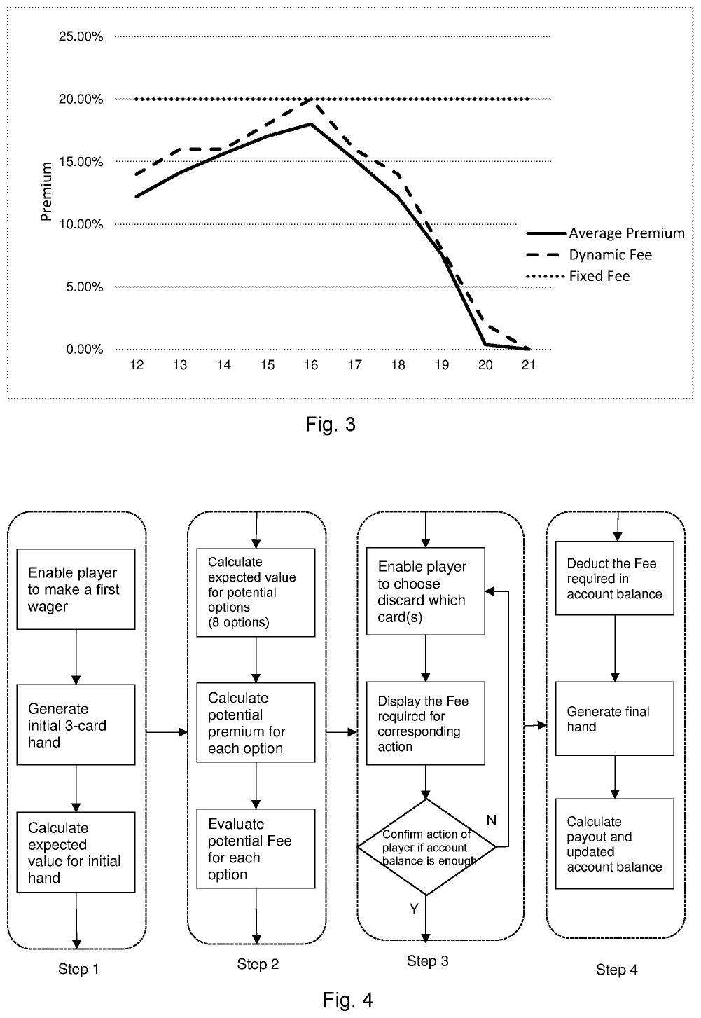

Example chargeable premium to offset player gained RTP advantage may be in the form of dynamic premiums commensurate with the gained RTP as set out in the last second row and in the form of a fixed fee as set out in the last row. A plot of apparent gain in RTP vs. the premium fee schemes is shown in FIG. 3. When applying a fixed fee scheme, for example a fixed fee scheme which is between the maximum and minimum gains a player may evaluate the advantage or disadvantage before deciding whether to apply.

In some embodiments, the chargeable premium is set to a fixed fee between the maximum and the minimum average increase in RTP, for example, at, say, 8%, 10%, 12%, 14%, 16% so that a user would need to make decision with reference to the instantaneous situation.

In some embodiments, the chargeable premium is to follow the trend of change in RTP but the exact amount may deviate from the actual percentage of change.

In some embodiments, the chargeable premium is set at discrete levels according to the increase in RTP, for example, a first fixed fee at a first range of increase in RTP etc.

Video poker is based on table-version five-card poker. It is typically an arcade or casino game played on a computerized console similar in size to a slot machine. After a player has made a contribution of money's worth as an ante, for example, by inserting a wager into the machine or by presenting a voucher such as a bar-coded paper ticket with credit to the machine, process begins when the player activates the machine by pressing a user interface, for example, a “deal” button. Upon initialization of the process, the player is given a hand of five information bearing devices, and each information bearing device resembles the information bearing surface of a playing card described hereinabove, and the information bearing devices, that is, cards, are arranged in-line. The player has the opportunity to discard one or more of the cards in exchange for new ones drawn from the same virtual deck. After the draw, the machine pays out if the hand or hands played match one of the winning combinations, which are posted in the pay table. Unlike the table version, the player may discard all the original cards if they so wish. Pay tables allocate the payouts for hands and are based on how rare they are, the game variation, and the decision of the game operator. A typical pay table starts with a minimum hand of a pair of jacks, which pays even money. All the other hand combinations in video poker are the same as in table poker, including such hands as two pair, three of a kind, straight (a sequence of 5 cards of consecutive value), flush (any 5 cards of the same suit), full house (a pair and a three of a kind), four of a kind (four cards of the same value), straight flush (5 consecutive cards of the same suit) and royal flush (a Ten, a Jack, a Queen, a King and an Ace of the same suit). Some machines offer progressive jackpots, or other unique bonuses, thereby spurring players to both play more coins and to play more frequently.

An example machine to run a process of the present disclosure is based on a machine of FIG. 1. An example process according to the present disclosure is described with reference to process and rules which are based on or similar to rules of conventional poker machines and table-version pokers for ease of understanding and the rules are incorporated herein by reference. The example process is to operate with only three information bearing devices for sake of simplicity and each information bearing device resembles a conventional playing card. The choice of only three cards to form a user hand is solely for ease of illustration to facilitate understanding and is by no means to form a limitation of disclosure. In example embodiments, the process may operate with 4, 5, 6 or more information bearing devices without loss of generality. The example process is referred to as mini-poker, for ease of reference.

In the example process, the pool of information bearing devices available for distribution to form a user hand is selected from a full deck of conventional cards, and more particularly consists of 20 cards comprising all the face cards, King/Queen/Jack, plus the Ten and Ace cards of the four suits. Example pay-out combinations and pay-out rates are set out in an example payout table, Table 6, below.

TABLE 6

| Pattern | | | Pay | Combinations | Probability | RTP |
|---|---|---|---|---|---|---|
| 3 of a | All Aces | | 5 | 4 | 0.35% | 1.75% |
| kind | Face Cards having same | | 2.5 | 12 | 1.05% | 2.63% |
| | alphabets | | | | | |
| | All Ten Cards | | 2 | 4 | 0.35% | 0.70% |
| Any pair | Plus Ace | Plus single | 2 | 16 | 1.40% | 2.81% |
| | | colour | | | | |
| Pair | of Aces | Plus single | 2 | 16 | 1.40% | 2.81% |
| | | colour | | | | |
| | Of Aces | | 1.5 | 80 | 7.02% | 10.53% |
| Any pair | plus Ace | | 1.5 | 80 | 7.02% | 10.53% |
| | In single colour | | 1.5 | 48 | 4.21% | 6.32% |
| Any pair | | | 1 | 240 | 21.05% | 21.05% |
| Any | Including | In single | 1 | 96 | 8.41% | 8.42% |
| Cards | Ace | colour | | | | |

| | | | | |
|---|---|---|---|---|
| In single colour | 0.5 | 64 | 5.61% | 2.81% |

| | | | | |
|---|---|---|---|---|
| Ace | 0.5 | 288 | 25.26% | 12.63% |
| Other | 0 | 192 | 16.84% | 0.00% |
| Total | | 1140 | 100% | 82.98% |

Initially, the machine is to select and distribute a player hand consisting of three cards to the player after a payment contribution, for example, as ante, of the player has been received. The three cards are selected randomly or pseudo-randomly from the pool of cards. After an initial player hand has been dealt, three cards forming the initial hand is presented on the VDU of the machine. The player is provided with optional features to proceed upon payment of a premium, known as feature fee. Example optional features include allowing the player to hold on all cards or to redraw some or all of the cards, and there are 8 possible alternative options available for the player to proceed after the initial hand has been dealt or distributed, as set out in Table 7 below.

TABLE 7

| Option | Card 1 | Card 2 | Card 3 |
|---|---|---|---|
| 1 | Hold | Hold | Hold |
| 2 | Hold | Hold | Discard |
| 3 | Hold | Discard | Discard |
| 4 | Hold | Discard | Hold |
| 5 | Discard | Hold | Hold |
| 6 | Discard | Discard | Hold |
| 7 | Discard | Hold | Discard |
| 8 | Discard | Discard | Discard |

The optional features are alternative options and each of the available options has an associated RTP that comes at a price. With the discard-and-redraw options available to a player, the RTP of the process is increased to 127.26%, assuming that a player is rational and will proceed with an option that results in a maximum RTP if to proceed exercising the discard-and-redraw option. Example interactions between a user and the machine during example processes are described below.

### Process Example 1

After a player has paid an initial wager, say $10, to the machine, the machine will issue an initial player hand to the player and the initial player hand consists of three example cards, for example, an Ace of diamond (red), a Ten of club (black) and a King of heart (red), and the cards forming the player hand will be presented on a display window of the machine. The initial player hand does not form a pay-out combination and the player may elect to redraw one or more cards to form a pay-out combination. Since there is one ACE, the apparent optimal strategy would seem to retain the Ace and discard the rest two cards and to get a redraw or a supplementary draw to replace the two discarded cards. The result after the supplementary draw results in a modified user hand consisting of an Ace of diamond (red, old), an Ace of club (black, new) and a Queen of diamond (red, new)

Since two Aces are present in this resulting hand, the player will receive a pay-out of 1.5 times the ante, i.e., $15 according to the pay-out rates set out in the pay-out table (Table 6).

### Process Example 2

After a player has paid an initial wager, say $10, as ante, the machine will issue to the player, as represented by the video display, an initial player hand of simulated cards consisting of three example cards, for example, a King of club (black), a Ten of club (black) and a King of heart (red).

The initial player hand contains a pair of KINGs and the player is entitled to a par pay-out of $10 according to the pay table. As there are two KINGs, the apparent optimal strategy would be to retain the KINGs and discard the rest (club 10) and to get a redraw or supplementary draw to replace the discarded card. The resulting player's hand after the supplementary draw is a modified player hand consisting of a King of club (black), a King of spade (black) and a King of heart (red). With 3 face cards forming the user hand, the machine will make a pay-out of 2.5 times the ante, i.e., $25, to the player according to the pay-out rates set out in the pay table.

### Process Example 3

After a player has paid an initial wager, say $10 to the machine, the machine will select at random three cards from the card pool and distribute the simulated cards to the player, as represented by the VDU, to form an initial user hand. The example initial player hand consists of a Ten of spade (black), a Ten of club (black) and a Jack of diamond (red). As the initial hand of cards contains two TENS of the same color, the player is already entitled to a pay-out of two times the ante, that is, $20. The player may, nevertheless, exercise an option to redraw, for example, by discarding the face card ‘Jack’ for a supplemental redraw, and the resulting modified player hand after the supplemental draw contains a Ten of spade (black), a Ten of club (black) and a Ten of club (black). In this example, the player has paid a premium (where a premium is payable) but does not get a better pay-out.

By providing a user an opportunity to discard and redraw a selected number of cards, the overall E(RTP) increases from 82.98% to 127.26%, which is much higher (44.28% higher) than a par RTP of 100%. However, as evident from process example 3, an increase in overall E(RTP) is an average and does not necessarily mean increase in RTP in each specific case.

In order to mitigate or off-set an increase in RTP, also known as expected value or EV, so that the host machine is not so much disadvantaged, the player is required to pay a fee, known as a premium or a feature fee, in order to exercise the optional features to discard a card or cards for redraw.

An example formula is to devise a premium with reference to the increase in RTP for each individual option or with reference to the differences in RTP between a discard-and-redraw option and the RTP of the initial hand, as set out in the expression or relationship below:

Potential Premium (i)=EV(Potential Options (i))−EV(Initial Hand).

The feature fee for electing feature option (i), where (i) is the identity number of an option may be set as below.

Feature Fee (i)=Rounded up Potential Premium (i) to the nearest even integer if the value of Potential Premium is positive, i.e., Potential Premium (i)>0, otherwise=0, where i=1, 2, 3, . . . 8 in the example of Table 7.

An example process flow to determine and apply applicable premium is shown in FIG. 2 and example interactive methods incorporating application of premium fees are described with reference to the situations below.

### Process Example A

After a player has paid an initial wager as ante, say $10, the initial player hand is distributed randomly by the machine to the user. The example initial player hand of this process example consists of a King of club (black), a Queen of spade (black) and a Jack of club (black). This initial hand of cards contains three face cards and the player is according to the pay table entitled to a pay-out equal to half the ante, i.e., $5. The player may wish to improve return by using an optional feature. The optional features include discarding some or all of the cards of the initial player hand for a supplemental redraw as set out in Table 7 upon payment of a premium fee, and the premium fee are set according to various factors according to the specific instant case, for example, the particular cards on hand, the number of cards to be redraw, the potential of a higher score on redraw, as set out in Table 8 below.

TABLE 8

| Card 1 | Card 2 | Card 3 | Premium | Fee |
|---|---|---|---|---|
| H | H | D | 35.29% | 36% |
| H | D | D | 35.29% | 36% |
| H | D | H | 57.35% | 58% |
| D | H | H | 35.29% | 36% |
| D | D | H | 57.35% | 58% |
| D | H | D | 57.35% | 58% |
| D | D | D | 73.53% | 74% |

H: HOLD;
D: DISCARD

With premiums set approximately between 35.29% to 73.53%, the resulting RTP will be below 100% to off-set the apparent increase in RTP and to bring the RTP more consistent with those without the optional features.

### Process Example B

After a player has paid an initial wager as ante, say $10, the initial player hand is distributed randomly by the machine to the user. The example initial player hand of this process example consists of a Queen of diamond (red), an Ace of club (black) and a Jack of spade (black).

The player is entitled to a $5 pay-out according to the pay table and the player may wish to improve return by using an optional feature. The optional features include discarding some or all of the cards of the initial player hand for a supplemental redraw as set out in Table 7 upon payment of a premium fee, and the premium fee are set according to various factors according to the specific instant case, for example, the particular cards on hand, the number of cards to be redraw, the potential of a higher score on redraw, as set out in Table 9 below.

TABLE 9

| Card 1 | Card 2 | Card 3 | Premium | Fee |
|---|---|---|---|---|
| H | H | D | 70.59% | 72% |
| H | D | D | −11.77% | 0% |
| H | D | H | 58.88% | 60% |
| D | H | H | 117.65% | 118% |
| D | D | H | 128.68% | 130% |
| D | H | D | 52.94% | 54% |
| D | D | D | 58.09% | 60% |

The amount of premium, that is, Potential Premium, payable by the player to offset the change in RTP according to Table 9 include both positive and negative values. In some embodiments, the machine may provide a reward to a player, for example, by way of credit, to encourage a player to use an option corresponding to a negative premium.

### Process Example C

After a player has paid an initial wager as ante, say $10, the initial player hand is distributed randomly by the machine to the user. The example initial player hand of this process example consists of a King of heart (red), an Ace of club (black) and an Ace of spade (black).

The initial hand of cards contains a two-ACE pay-out combination and the player is entitled to a pay-out of $20 according to the pay table. The player may wish to consider using an optional feature. The optional features available for use include discarding some or all of the cards of the initial player hand for a supplemental redraw as set out in Table 7, and the premium fees for each available option set according to the example formula are tabulated in Table 10 below.

TABLE 10

| Card 1 | Card 2 | Card 3 | Premium | Fee |
|---|---|---|---|---|
| H | H | D | −141.18% | 0% |
| H | D | D | −141.18% | 0% |
| H | D | H | −150.00% | 0% |
| D | H | H | 129.41% | 130% |
| D | D | H | −97.79% | 0% |
| D | H | D | −97.79% | 0% |
| D | D | D | −151.76% | 0% |

Most of the premiums set out in Table 10 and calculated according to the example formula for this process example are negative values corresponding to no fee payable by the player to exercise the option, indicating no potential improvement or expected gain on exercising the option. The only option requiring a positive premium is associated with a Discard/Hold/Hold (D-H-H) option, meaning discarding the non-Ace card to hope for another Ace card to get a 3-Ace combination at a return of three times the ante. As D-H-H is the only apparent option that would result in increased RTP, this is likely to be the only option to be elected by the player.

With the application of a chargeable premium to offset player's gained advantage, the overall RTP will drop from 127.26%, with free options to use the features, to around 82%, when exercise of an option is subject to payment of a premium fee. The example premium fee is a dynamic premium which is set to correspond to or commensurate with the apparent increase in RTP or to bring the resulting RTP (with option to use a feature) close to the RTP of the initial player hand with no useable feature.

Where the calculated premium has a negative value, the machine may provide a reward to a player, for example, by way of credit, to encourage the player to use an option corresponding to a negative premium. The reward may correspond or commensurate with the calculated premium with negative meaning ‘pay to player’ or lower than the absolute value of the premium to achieve a better house edge.

Application of a dynamic fee to offset the player's gained advantage or apparently gained advantage is believed to make it fairer for both skilled and un-skilled players. Of course, a fixed premium may be levied and a player would need to exercise skill to interact with the machine and determine whether to use an option when presented with an option to elect.

In an example process, the machine is to operate using five information bearing devices as a conventional poker machine or a conventional table version poker. The example process is implementable using the same machine configuration of FIG. 1.

Initially, the machine is to select and distribute a player hand consisting of five cards to the player after a payment contribution, for example, as ante, of the player has been received. The cards forming the initial player hand are selected randomly or pseudo-randomly from the pool of cards. The process has an associated payout table and RTP as depicted in Table 11 below.

TABLE 11

| Hand | Pay | Combinations | Prob | RTP |
|---|---|---|---|---|
| Royal Flush | 800 | 4 | 0.000% | 0.12% |
| Straight Flush | 50 | 36 | 0.001% | 0.07% |
| Four of a kind | 25 | 624 | 0.024% | 0.60% |
| Full House | 9 | 3744 | 0.144% | 1.30% |
| Flush | 6 | 5108 | 0.197% | 1.18% |
| Straight | 4 | 10200 | 0.392% | 1.57% |
| Three of a kind | 3 | 54912 | 2.113% | 6.34% |
| Two Pair | 2 | 123552 | 4.754% | 9.51% |
| Jacks or Better | 1 | 337920 | 13.002% | 13.00% |
| All Other | 0 | 2062820 | 79.371% | 0.00% |
| Totals | | 2598960 | 100.000% | 33.69% |

When the discard-and-redraw option is made available to the player, the values of Table 11 will be modified to those of Table 12.

TABLE 12

| Hand | Pay | Combinations | Prob | RTP |
|---|---|---|---|---|
| Royal Flush | 800 | 41,126,022 | 0.002% | 1.98% |
| Straight Flush | 50 | 181,573,608 | 0.011% | 0.55% |
| Four of a kind | 25 | 3,924,430,647 | 0.236% | 5.91% |
| Full House | 9 | 19,122,956,883 | 1.151% | 10.36% |
| Flush | 6 | 18,296,232,180 | 1.101% | 6.61% |
| Straight | 4 | 18,653,130,482 | 1.123% | 4.49% |
| Three of a kind | 3 | 123,666,922,527 | 7.445% | 22.33% |
| Two Pair | 2 | 214,745,513,679 | 12.928% | 25.86% |
| Jacks or Better | 1 | 356,447,740,914 | 21.459% | 21.46% |
| All Other | 0 | 906,022,916,158 | 54.543% | 0.00% |
| Totals | | 1,661,102,543,100 | 100.000% | 99.54% |

It is noted that there is a surge in expected return (RTP) when the discard-and-redraw option is available and the increase is: 99.54%−33.69%=65.85%.

### Process Example D

In an example process based on the 5-card process, the machine is to issue a player hand of 5 cards to the player after a player has paid an initial wager as ante, say $10. The example initial player hand of this process example consists of a 3 of club, a 7 of spade, a 9 of spade, a Queen of spade and a Queen of diamond. When a player elects to use an optional feature, a sensible approach is to retain the Queens while discarding the rest for redraw to hope for a higher return.

A resulting redrawn hand may consist of, for example, a 2 of club, a 3 of diamond, a 7 of diamond, a Queen of spade and a Queen of diamond, resulting in no improvement in payout but at a paid premium.

### Process Example E

In an example process based on the 5-card process, the machine is to issue a player hand of 5 cards to the player after a player has paid an initial wager as ante, say $10. The example initial player hand of this process example consists of an Ace of club, a King of club, a Queen of club, a Jack of club and a 5 of heart. When a player elects to use an optional feature, a possible approach is to retain the Clubs while discarding the rest for redraw to hope for a higher return.

A resulting redrawn or modified hand may consist of, for example, an Ace of club, a King of club, a Queen of club, a Jack of club and a 10 of Club, scoring a Royal Flush with a 800 times payout at a comparatively low premium.

Keno is a lottery-like process. A player is to participate in the processing by paying an ante and by choosing a pool of numbers to form a player hand. The pool of number usually includes numbers between 1 and 80. After all participating players have settled with selected numbers to form player hands, a set of numbers, for example 20 numbers, is drawn at random, either with a ball machine similar to ones used for lotteries and bingo, or with a random number generator (RNG). A player will receive a payout according to the number of selected numbers matched with the drawn numbers.

There are also ancillary modes or optional modes in conventional Keno games in addition to the number-matching game proper.

Large/Small

In this optional mode, a player can make a side bet on whether the sum of numbers carried on the balls drawn is larger or smaller than a dividing sum. For example, a sum of 33 or larger (for the 80-ball model) may be considered Large or Big and a sum less than 33 is counted as Small. The associated odds and RTP are set out in Table 14 below.

TABLE 14

| | BIG | SMALL | DRAW |
|---|---|---|---|
| RANGE | 21-32 | 34-45 | 33 |
| PROB | 45.71% | 45.71% | 8.57% |
| ODDS | 2.1 | 2.1 | 11.2 |
| RTP | 96.00% | 96.00% | 96.00% |

Odd/Even

In another optional mode, a player can make a side bet on whether there are more even balls or more odd balls among the drawn balls. In this mode, players are allowed to choose ODD/EVEN/DRAW and the associated odds and RTP are set out in Table 15 below.

TABLE 15

| | Odd/Even | | |
|---|---|---|---|
| Options | Odd | Even | Draw |
| Odds | 3.55 | 3.55 | 1.95 |
| Probability | 26.19% | 26.19% | 47.62% |
| RTP | 92.98% | 92.98% | 92.86% |

A player may participate in the process, for example, by participating in the game proper, an optional mode or optional modes, or a combination thereof. Below are some examples of process participation by a player.

### Example 1: Player Wagers for a Normal Game Plus 2 Optional Modes

Normal Game: Bet $1 on “7”, “8”, “9” & “10”.
BIG/SMALL: Bet $1 on “BIG”.
ODD/EVEN: Bet $1 on “ODD”.

System generates the numbers: “1”, “2”, “4”, “5”, “7” & “8”.

Results:
Normal Game: two numbers matched, $0.6 payout, 60% return rate.
BIG/SMALL: 1+2+4+5+7+8=27<33, which is not “BIG”, player Loses.
ODD/EVEN: 3 odd and 3 even numbers, a DRAW and player loses.

Overall result: player paid $3 in total and gets back $0.6, a loss of $2.4 or −80%.

### Example 2: Player Wagers for a Normal Game Plus 2 Optional Modes

Normal Game: Bet $10 on “1”, “4”, “5” & “10”
BIG/SMALL: Bet $5 on “DRAW”
ODD/EVEN: Bet $5 on “ODD”

System generates the numbers: “2”, “3”, “6”, “7”, “8” & “9”.

Results:
Normal Game: No player's selection matched-player loses all.
BIG/SMALL: 2+3+6+7+8+9=35>33, which is “BIG”-player loses.
ODD/EVEN: 3 odd and 3 even numbers, a DRAW and player loses.

Result: player bets $20 in total and lost all.

### Example 3: Player Wagers for a Normal Game Plus 2 Optional Modes

Normal Game: Bet $10 on “5”, “6”, “7” & “8”
BIG/SMALL: Bet $10 on “DRAW”
ODD/EVEN: Bet $10 on “DRAW”

Result—System generate “3”, “4”, “5”, “6”, “7” & “8”.
Normal Game: player's selection all matched. Player wins and receives a payout of $10×2.6=$26.
BIG/SMALL: 3+4+5+6+7+8=33, which is “DRAW”. Player wins and receive a payout of $10×11.2=$112.
ODD/EVEN: 3 odd and 3 even numbers, which is a DRAW. Player wins and receive a payout of $10×1.95=$19.5.

Result: Player bets $30 in total, and gets back $26+$112+$19.5=$157.5 in return.

### Example Process

An example process according to the disclosure is described with reference to process and rules based on or similar to rules of conventional Keno for ease of understanding, and the rules are incorporated herein by reference. The example process is to operate with an example plurality of ten number bearing balls and each numbered ball carries a number on its outer surface. A player is to select four numbers to form a player hand upon payment of an ante, a total of six balls is to be drawn by a host, and the payout payable to the player depends on the number of drawn numbers correctly selected by the player. The choice of ten numbers to form a full pool, six balls to be drawn by the host to form a host hand, and four balls to be selected by a player to form a player hand, is only an example selected for simplicity and for ease of illustration, and is by no means intended to form a limitation of disclosure. In actual implementations, the number of balls forming the pool may be any number, the numeric values on the balls may be sequential or non-sequential and may begin from 1 or otherwise, the number of balls forming a hand may be any number which can be larger than or smaller than six for a host hand and four for a player hand without loss of generality.

Example pay-out combinations and pay-out rates of the example process of the present disclosure are set out in an example payout table of Table 13 below.

TABLE 13

| Catches | Combinations | Probability | Odds | RTP |
|---|---|---|---|---|
| 4 | 15 | 7.14% | 2.6 | 18.57% |
| 3 | 80 | 38.10% | 1.3 | 49.52% |
| 2 | 90 | 42.86% | 0.6 | 25.71% |
| 1 | 24 | 11.43% | 0.2 | 2.29% |
| 0 | 1 | 0.48% | 0 | 0.00% |
| Total | 210 | 100.00% | | 96.10% |

An example machine to run a process of the present disclosure may be based on a machine having a configuration of FIG. 1. A player may participate in the example process, for example, thorough interaction with the machine by means of the user interface and the VDU, or in real life as a live-game with human-human interaction.

In example processes, a player is to form a player hand in a plurality of stages, and the host is to draw the host hand in a corresponding plurality of stages. For example, a player is required to select two numbers to form a first portion of a player hand at beginning of process upon payment of an ante to begin a first stage of the process. The machine will then draw two numbered balls from the pool of numbered balls to form a first portion of the host hand to conclude the first stage of the process. After the two numbered balls have been drawn, the player may proceed to the next stage of the process or abort. If to proceed, the player is to select another two numbers (different from the two drawn numbers) to form a second portion of the player hand to commence the second stage of the process and to form the complete player hand consisting of the first portion and the second portion. The machine will then draw four numbered balls from the remaining eight balls of the pool of numbered balls to form a second portion of the host hand to form the complete host hand consisting of the first portion and the second portion and to conclude the second stage of the process. Below are some example scenarios.

### Example Scenario 1

First stage bet: $1 ante on “7”, “8”.
First stage draw: “1”, “2”.
First portion of player hand has no catch, no payout if abort.
Increase in RTP: 0%.
Player hand second stage selection: “9” & “10”
Second stage outcome: “4”, “5”, “6” & “7”.
Result: number “7” caught by player.
Total payout: $0.2.
Result: 20% actual RTP.

### Example Scenario 2

First stage bet: $10 ante on “1”, “8”.
First stage draw: “1”, “6”.
First portion of player hand has one catch, $2 payout if not to proceed.
Increase in RTP: 101.43%−68.86%=32.57% 34%).
Player hand second stage selection: “7” & “5”
Second stage outcome: “3”, “5”, “9” & “4”.
Result: numbers “1” and “5” caught by player.
Total payout: $6 (two catches).
Result: 60% actual RTP without premium; 44.8% if a premium of $3.4 is paid.

### Example Scenario 3

First stage bet: $10 ante on “6”, “8”.
First stage draw: “6”, “8”.
First portion of player hand has one catch, $6 payout if not to proceed.
Increase in RTP: 142.86%−68.86%=74%.
Player hand second stage selection: “10” & “5”
Second stage outcome: “3”, “5”, “9” & “10”.
Result: numbers “5”, “6”, “8” and “10” caught by player.
Total payout: $26 (four catches, $10×2.6 odds).
Result: 260% actual RTP without premium; 149.4% if a premium of $74 is paid.

The RTP (return-to-player) is higher in the split process version compared to a single stage process version, and the potential increase in the RTP can be expressed by the below relationship:

ΔRTP(i)=EV_{split process}(i)−EV_{single process}, where ΔRTP is the change in expected RTP, EV_{single process}(i) is the expected RTP of the split process for a scenario (i), and EV_{single process} is the expected RTP of the single process version.

In order to equalize or mitigate the apparent gain in RTP, a player will be required to pay a premium in order to proceed to the second stage of the process, since odds are not in a linear scale, as evident from Table 13. Example premium may be set according to the relationship: Premium payable=ΔRTP or (ΔRTP) rounded up.

For example, there is no increase in RTP in the first stage of example scenario 1 and no premium is payable, there is an increase in RTP of 32.57% in the first stage of example scenario 1 and a premium of $34 of the ante is payable, and there is an increase in RTP of 32.57% in the first stage of example scenario 1 and a premium of $74% of the ante is payable.

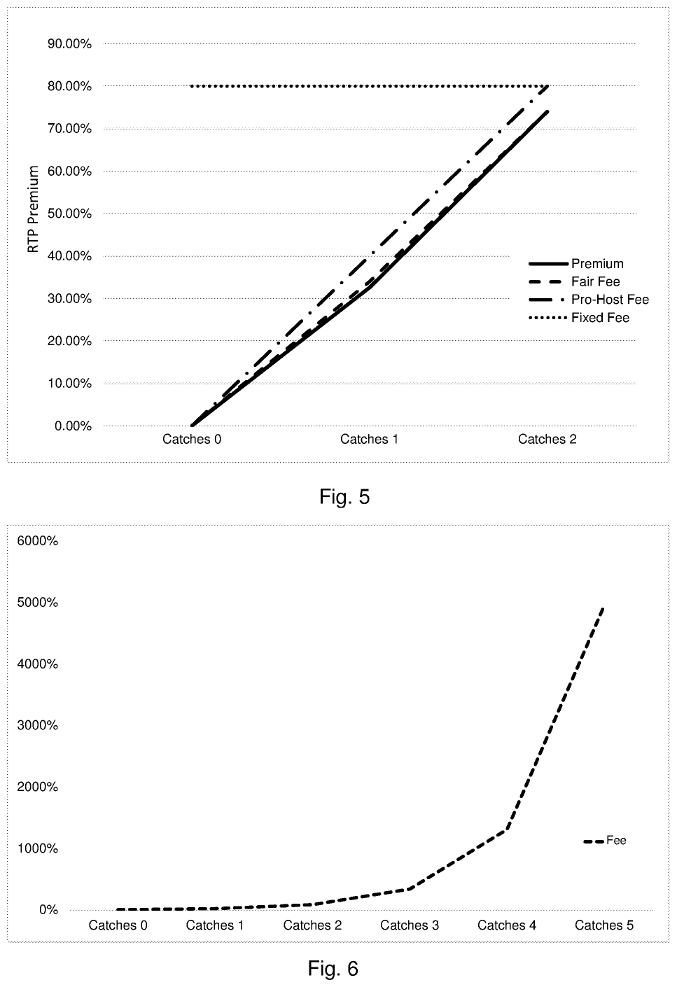

The payable premium may be set as a fair fee which is comparable to the increase in RTP, a pro-host fee which is higher than the increase in RTP and a fixed fee, as depicted in the example of Table 16 below and the example trend as shown in FIG. 5.

TABLE 16

| Catch | Premium | Fair Fee | Pro-Host Fee | Fixed Fee |
|---|---|---|---|---|
| 0 | 0.00% | 0.00% | 0.00% | 80.00% |
| 1 | 32.57% | 34.00% | 40.00% | 80.00% |
| 2 | 74.00% | 74.00% | 80.00% | 80.00% |

Levying a premium on the player would offset the player's advantage in using an optional feature or to increase the host's advantage. The premium may be in the form of a fixed fee, a pro-host fee and/or a fair (relatively) fee.

In example processes, a player is to select a set of numbers at the beginning of process to form a first portion of the player hand, and the host is to draw a set of numbers to form a first portion of the host hand. The first portion of the player hand may consist of two numbers and the first portion of the host hand may consist of between one and five numbered balls, which means a player may have between a zero catch and two catches. A catch herein means a number forming a player hand is drawn by the host. It is assumed that the increase in RTP in the example processes is dependent on the number of catches, that is, the number of balls chosen by the player and correspondingly drawn by the host and a prediction of dynamic premium fee is shown in FIG. 6.

Optional Modes with Dynamic Fee

The premium fee mechanism, or more specifically the dynamic fee mechanism, may also apply to optional process modes, for example, the “BIG/SMALL” & “ODD & EVEN”.

For example, instead of making a bet for an optional mode before the beginning of process, a player may decide whether and how to make the bet after the first stage of the process has concluded. Alternatively, a player may have made a decision at the beginning of process, but would like to change bet after the first stage. Below are some examples of “ODD & EVEN” scenarios.

### Example Scenario 1A

First stage bet: $10 ante on “Even”.
First stage draw: “1”, “2”.
Player hand second stage selection: to change from “Even” to “Draw”.
Premium levied for change after first stage: 16% of ante.
Second stage outcome: “4”, “5”, “6” & “7”.
Result: “Draw”.
Total payout: $10×1.95=$19.5.
Total bet: $11.6.
Actual RTP after premium paid: 168.1%.

After the first stage, the instantaneous expected returns are set out in Table 17.

TABLE 17

| | Item | | |
|---|---|---|---|
| | Odd/Even | | |
| Option | Odd | Even | Draw |
| Probability | 24.29% | 24.29% | 51.43% |
| Expected RTP | 86.21% | 86.21% | 100.29% |

As the expected RTP of Draw is increased by 14.08% from 86.21% for Odd to 100.29% for Draw, a premium of 16% of the ante is levied to offset the increase. Of course, the premium may be set to 14% or lower.

### Example Scenario 2A

First stage bet: $10 ante on “Odd”.
First stage draw: “1”, “3”.
Player hand second stage selection: no change.
Premium levied for change after first stage: no levy.
Second stage outcome: “4”, “5”, “6” & “7”.
Result: “Odd”.
Total payout: $10×3.55=$35.5.
Actual RTP after premium paid: 355%.

After the first stage, the instantaneous expected returns are set out in Table 18.

TABLE 18

| | Item | | |
|---|---|---|---|
| | Odd/Even | | |
| Option | Odd | Even | Draw |
| Prob | 74.29% | 1.43% | 22.86% |
| RTP | 263.71% | 5.07% | 44.57% |

Since the RTP for Odd is substantially higher than the RTP of others, the RTP for Odd is the maximum of the RTPs of the available options and a rational player would be expected to retain its position. In some embodiments, the host may invite a player to change position, for example, by giving a bounty or bonus, for example a bounty higher than the ante, say, 200%.

### Example Scenario 3A

First stage bet: $10 ante on “Draw”.
First stage draw: “2”, “4”.
Player hand second stage selection: to change from “Draw” to “Even”.
Premium levied for change after first stage: 220% of ante.
Second stage outcome: “8”, “5”, “6” & “7”.
Result: “Odd”.
Total payout: $10×3.55=$35.5.
Total bet: $32 ($10(initial)+$22 (premium)).
Actual RTP after premium paid: 110.9%.

After the first stage, the instantaneous expected returns are set out in Table 19.

TABLE 19

| | Item | | |
|---|---|---|---|
| | Odd/Even | | |
| Option | Odd | Even | Draw |
| Prob | 1.43% | 74.29% | 22.86% |
| RTP | 5.07% | 263.71% | 44.57% |

Since the RTP for Even is substantially higher than the RTP of others, the RTP for Even is the maximum of the RTPs of the available options and a rational player would be expected to be attracted to change its position to Even upon payment of a premium. As there is an increase of slightly less than 220% in RTP, the premium was set as 220% to offset the gain in RTP. In some embodiments, the host may invite a player not to change position, for example, by giving a bounty or bonus, for example a bounty higher than the ante, say, 100%, 150% or 200%.

Big/Small

A summary of RTP and increase in RTP for some example “BIG/SMALL” scenarios is set out in Table 20, where the symbol (1,2) means balls numbered “1” & “2” are drawn in the first stage. The Fee of decision change refers to the different in RTP between the original choice and the new choice that rounding to the nearest 2%

TABLE 20

| | | Small | Big | Draw |
|---|---|---|---|---|
| | Range | 21-32 | 34-45 | 33 |
| | Odds | 2.1 | 2.1 | 11.2 |
| RTP | Normal | 96.00% | 96.00% | 96.00% |
| | (1, 2) | 174.00% | 21.00% | 80.00% |
| | (3, 5) | 120.00% | 72.00% | 96.00% |
| | (1, 9) | 105.00% | 84.00% | 112.00% |
| | (9, 10) | 21.00% | 174.00% | 80.00% |

For example, where balls numbered “1” & “2” are drawn in the first stage, the instantaneous RTP is 174% for Small, 21% for Big and 80% for Draw. If a player made a bet for Draw and wishes to change the bet from Draw to Small after the first stage result is known, the player will be expected to pay a levy to off-set the change in expected RTP. For example, the player may be charged 94% (174%-80%=94%) to make the change.

For example, if a player wishes to change from BIG to DRAW under the case of (1,9), a player would need to pay a premium say 8% to offset the gain of 7% in RTP (112%-105%=7%). Once the player wins, the player can get a payout of 11.2 times the ante.

While the present disclosure has been described with reference to the example methods, it should be appreciated that the interactive methods and machines are non-limiting examples and should not be used to limit scope of the present disclosure. For example, while the examples refer to playing cards or numbered balls as example of information bearing devices, information bearing devices suitable for the disclosure can be in other forms, for example, as dominos such as Mahjong, PaiGow, etc.

Table of numerals

| | | | |
|---|---|---|---|
| Housing | 110 | Data storage device | 114 |
| Microprocessor | 112 | User interface | 116 |
| Video display unit | 118 | Communication front end | 119 |
| First stage process | 130 | Second stage process | 138 |

1. An apparatus comprising a controller, a data storage device, a user operable user interface and a display apparatus, wherein the controller is to execute stored instructions to operate to implement a gaming process comprising a first stage operation and a second stage operation; wherein, in the first stage operation, the controller is to issue a first set of information bearing devices forming a first portion of a host hand and/or a first portion of a user hand having a corresponding expected value of return-to-player, wherein the controller is to provide the user with an option to use a feature at a premium, and the use of the feature is to result in a change in expected return-to-player; wherein the controller is to implement the feature upon receipt of the premium and upon receipt of user instruction to proceed to the second stage operation; and wherein, in the second stage operation, the controller is to issue a second set of information bearing devices forming a second portion of the host hand to form a complete host hand and/or a second portion of a user hand to form a complete user hand, and the controller is to determine process outcome of the process and payout with reference to the user hand and the host hand.

2. The apparatus according to claim 1, wherein the premium is dynamically determined by the controller with reference to the user hand and with reference to the extent of change in expected return-to-player with respect to the expected return-to-player prior to using the feature.

3. The apparatus according to claim 1, wherein the controller is to set the premium to commensurate with the instantaneous change in return-to-player.

4. The apparatus according to claim 1, wherein the user is to contribute the premium to the host by operation of the user interface and the controller is to implement the feature upon detection of contribution of the premium.

5. The apparatus according to claim 1, wherein the change in expected return-to-player can be positive or negative, and the premium can be positive or negative.

6. The apparatus according to claim 1, wherein the controller in the first stage operation is:
to operate as a dealing host to select a first set of information bearing devices from a pool of information bearing devices forming a deck, and to present the first set of information bearing devices on the display apparatus to represent the first portion of the user hand which is distributed by the host to the user at beginning of process after the host has received a user contribution of value in form of an ante, wherein the user hand has an accompanying expected rate of return-to-player defining an initial RTP, and the user is expected to make a decision to perform a next move and to inform the controller to perform the next move through operation of the user interface;
to provide the user with an option or options to use a feature at a premium, wherein exercise of the option or options is to result in an apparent change in RTP, and wherein the premium is set by the controller to fully off-set or partially off-set the apparent change in RTP; and
to implement the feature after the user has contributed the premium to the host;
wherein the controller in the second stage operation is to select a second set of information bearing devices from the pool of information bearing devices to complete formation of the user hand and the host hand, and to determine outcome of the process based on a set of predetermined rules and to present the process outcome on the display apparatus.

7. The apparatus according to claim 6, wherein the user is at liberty to make a request for an additional information bearing device to increase score values of the user hand provided the user hand score is below a maximum, and wherein the controller is to issue an additional information bearing device upon receipt of the request.

8. The apparatus according to claim 1, wherein the process outcome includes a winning situation, a push situation and a losing situation, wherein a user wins an amount commensurate to the value of the ante in the winning situation, draws and retain the ante in the push situation, and loses the ante or part thereof in the losing situation.

9. The apparatus according to claim 1, wherein each information bearing device resembles or is to simulate a playing card, and the process adopts basic rules of Blackjack.

10. The apparatus according to claim 1, wherein each information bearing device has an accompanying score value and the controller is to determine the process outcome with reference to total score values of the host hand and the player hand; wherein the controller is to operate to issue two information bearing devices to the host as an initial host hand, wherein each information bearing surface has an information-bearing surface on a first side and a non-information-bearing surface on a second side opposite to the first side; wherein one of the information bearing devices of the initial host hand has its information bearing surface hidden from the user as a hidden information bearing surface and the initial RTP is with respect to the initial host hand; and wherein the controller is to exposed the hidden information bearing surface to the user to form an open host hand upon the user exercising the option to use the feature to result in the apparent change in the RTP with respect to the initial RTP.

11. The apparatus according to claim 1, wherein the first portion of the host hand consists of a first card having a hidden information bearing surface and a second card having an exposed information bearing surface; wherein the controller upon receipt of the premium is to expose the hidden information bearing surface, whereby the expected value of return-to-player is changed.

12. The apparatus according to claim 1, wherein the apparatus adopts payout rules of a poker machine or a video poker, and the first set of information bearing device comprises a plurality of information bearing device each having an information bearing surface resembling an information bearing surface of a playing card; and wherein the user is to select one information or a plurality of information bearing devices from the first set of information bearing device to form a group for discard, redraw and replacement on using the feature, and wherein the controller is to discard the group and redraw replacement information bearing device or information bearing devices to replace the group to form a complete user hand.

13. The apparatus according to claim 12, wherein the controller is to determine the expected value of return-to-player after issue of the first set of information bearing devices and to determine the premium dynamically depending on constitution of the first set of information bearing devices.

14. The apparatus according to claim 1, wherein the first set of information bearing devices comprises a first plurality of information bearing device each having an information bearing surface and resembling a numbered ball, and the controller in the first stage operation is to issue the first set of information bearing device to form a first portion of the host hand; wherein the user is to select a corresponding plurality of numbers to form a first portion of the user hand before the first set of information bearing device issued; wherein the controller is to determine the premium payable by the user to proceed to the second stage of operation as an optional feature and the premium is determined instantaneously with reference to the information bearing devices forming the first set of information bearing devices; and wherein the user is to select a second plurality of numbers to complete formation of the user hand before the controller completes formation of the host hand for display.

15. The apparatus according to claim 14, wherein the apparatus adopts payout rules of Keno.

16. A method of implementing a gaming process by a machine comprising a solid-state controller comprising a microprocessor, wherein the gaming process comprises a first stage operation and a second stage operation, and the method comprises the controller:
executing stored instructions to issue a first set of information bearing devices forming a first portion of a host hand and/or a first portion of a user hand having a corresponding expected value of return-to-player,
providing the user with an option to use a feature at a premium, and the use of the feature is to result in a change in expected return-to-player,
implementing the feature upon receipt of the premium and upon receipt of user instruction to proceed to the second stage operation in the first stage operation;
issuing a second set of information bearing devices forming a second portion of the host hand to form a complete host hand and/or a second portion of a user hand to form a complete user hand, and
determining process outcome of the process and payout with reference to the user hand and the host hand in the second stage operation.

17. The method according to claim 16, wherein the second stage operation is an optional stage and the controller is to compute the change in expected return-to-player at end of the first stage operation and determine the premium payable by the user.

18. The method according to claim 16, wherein the controller in the first stage operation is to operate as a dealing host to select a first set of information bearing devices from a pool of information bearing devices forming a deck, and to present the first set of information bearing devices on a display apparatus to represent the first portion of the user hand which is distributed by the host to the user at beginning of process after the host has received a user contribution of value in form of an ante, wherein the user hand has an accompanying expected rate of return-to-player defining an initial RTP, and the user is expected to make a decision to perform a next move and to inform the controller to perform the next move through operation of the user interface.
